(19) United States
(12) Patent Application Publication
(10) Pub. No.: US 2020/0216244 A1
(43) Pub. Date: Jul. 9, 2020

(54) BIODEGRADABLE PACKAGING, METHOD FOR MANUFACTURING SAME AND USES THEREOF

(71) Applicant: VEGEPLAST, BAZET (FR)

(72) Inventors: Vincent PLUQUET, MONSEGUR (FR); Guillaume BEAUVAIS, BAZET (FR); Xavier GARREAU, TOULOUSE (FR)

(21) Appl. No.: 16/625,033

(22) PCT Filed: Jun. 28, 2018
(86) PCT No.: PCT/FR2018/051596

§ 371 Date: Dec. 20, 2019

(30) Foreign Application Priority Data
Jun. 28, 2017 (FR) 1755928

(51) Int. Cl. B65D 65/46; B65D 81/34; B65D 81/26; A23L 5/10; B29C 45/14

(52) U.S. Cl. CPC B65D 65/466; B65D 81/34; B65D 81/267; B65D 81/264; A23L 5/10; B29K 2711/12; B29C 45/14811; B65D 2565/385; A23V 2002/00; B29C 2045/14918; B29K 2995/006; B29C 45/14336

(57) ABSTRACT

Disclosed is a biodegradable packaging including: —a biodegradable substrate including a bottom from the edge of which a wall rises so as to define an inner face capable of containing an item, such as a food item or a plant; —a biodegradable film. The biodegradable substrate includes one or more openings arranged on the bottom and/or the wall, the biodegradable film being positioned on the inner face of the biodegradable medium so as to seal at least the openings. The biodegradable film is positioned on the biodegradable substrate by the in-mould labelling technique.

### TECHNICAL FIELD TO WHICH THE INVENTION RELATES

The present invention relates to the field of biodegradable items.

In particular, the present invention refers to a packaging, such as a tray, that is biodegradable and lightweight, to the method for manufacturing the same and to the uses thereof.

The packaging according to the invention may in particular be useful in the field of agriculture for transporting vegetables, fruits or also plants, or in the field of food for packing foodstuffs (meat, cheese, fish) or for cooking dishes.

### TECHNOLOGICAL BACK-GROUND

In order to limit the impact of wastes on the environment, biodegradable packaging, such as trays used for packing, storing and/or transporting foodstuffs, is in full expansion and replace gradually the packaging made of non-biodegradable plastic material.

In this field, it is for example known to use trays made of a polylactic acid (PLA) material. This material is used either pure or mixed with other biodegradable materials.

When used pure, PLA is watertight but has however the drawback to be brittle. It is hence most often mixed with another biodegradable material.

Another drawback of the biodegradable materials, including PLA, is that they do not form a gas barrier, for example to oxygen. In the field of food packaging, if a tray made of biodegradable material is used and if a barrier to gas (and possibly to water) is desired to be made, a film, which is most often non-biodegradable, is used.

Document FR 2 947 205 is also known in the state of the art. This document describes a biodegradable tray that is watertight and/or adapted to form a gas barrier. The tray is in particular made of a multilayer material composed of a first layer of agro-material, a second layer of paper, and a third layer of biodegradable resin, the layer of paper being taken in sandwich between the first layer of agro-material and the third layer of resin.

However, this tray has the drawback to have a quite significant weight that may generate relatively high manufacturing costs.

Document EP 2835320 describes a packaging comprising a container possibly provided with a lid. The container is formed of a rigid frame composed of plastic ribs forming the bottom and the four walls of the packaging. Each of the walls may comprise so-called reinforcing, additional ribs. The bottom and the four walls are formed of different layers of paper or cardboard. According to a first embodiment, the different layers of paper or cardboard forming the bottom and the walls of the packaging are inserted into an injection mould, then plastic material is injected to form the rigid frame (ribs). According to a second embodiment, the plastic material is injected into the mould to form the rigid frame, then the different layers of paper or cardboard are positioned between the ribs when these latter are still in the tacky state resulting from the injection process.

The packaging described in this document has nevertheless the drawback to be difficult to implement. As regards the first embodiment, it seems not possible to make the cardboard layers adhere/stick during the rigid frame injection step, because they are too thick. Moreover, it is necessary to position the layer forming the bottom and the four layers forming the four walls into an injection mould, while maintaining them in place. This document does not mention how this is made. Moreover, the angle areas of the rigid frame being formed by ribs, it hence seems not possible to remove the part from the mould after the injection step, due in particular to the undercuts inherent to the injection. The second embodiment seems difficult to implement at industrial scale or requires specific injection machines.

Document DE 20 2016 103684 describes a wicker basket comprising a bottom from which extends a wall that comprises openings. A hemispherical container is adapted to be positioned inside the wicker basket.

Document LU 49 758 describes a crate for packing salads and garden produce. It comprises a crate frame adapted to receive a small box made of plastic sheet.

These two documents are however not intended for packing small containers of the ready meal tray type. Moreover, the wicker substrate of the basket or the wood substrate of the crate is not very lightweight.

Hence, there exists a need for new biodegradable packagings, being lightweight while having excellent mechanical properties (resistance to vertical compression, to lateral and bottom pressures, or also impact resistance) that guarantee the packaging functionality.

There also exists a need for a packaging that is watertight and adapted to form a gas barrier.

It would hence be desirable to have new packagings, in particular biobased and/or biodegradable, non-toxic, suitable for food contact, having a reduced weight with respect to the packagings traditionally used, for example, in the field of food (cooking packaging or packaging for fruits, vegetables, meats, cheeses, etc.), while having a certain stiffness, so that the tray does not lose functionality.

An object of the present invention is hence to propose a new packaging that avoids, at least in part, the above-mentioned drawbacks.

### OBJECT OF THE INVENTION

The present invention provides a technical solution to the problems identified hereinabove.

The present invention proposes a biodegradable packaging comprising:

(i) a biodegradable substrate comprising a bottom from the edge of which a wall rises, so as to define an inner face adapted to contain an item, such as a foodstuff or a plant;

(ii) a biodegradable film,

characterized in that said biodegradable substrate comprises one or several openings arranged in the bottom and/or the wall, said biodegradable film being positioned on said inner face of said biodegradable substrate so as to obturate at least said openings and in that said biodegradable film is positioned on said biodegradable substrate by the in-mould labelling technique.

According to the present invention, the in-mould labelling technique is also called IML.

The Applicant has indeed surprisingly discovered that combining a biodegradable substrate having openings, i.e. recessed areas, with a biodegradable film adapted to obturate the openings, makes it possible to produce a packaging having both a light weight and good mechanical properties. Indeed, the packaging according to the invention is adapted to transport, package or store foodstuffs (meats, vegetables or fruits) or also plants (for example, it may be used as a flowerpot). It is also adapted to form capsules, such as coffee capsules.

The Applicant has also unexpectedly discovered that this combination is made possible thanks to the use of the IML technique. Indeed, a single biodegradable film may be arranged on the substrate in such a way to conform the inner face thereof and hence to fill the openings, and that in a simple and easy-to-implement manner (IML). Moreover, the Applicant has shown that, contrary to what the one skilled in the art might have expected, the (single) biodegradable film according to the invention does not form waves during the packaging removal from the mould. Indeed, in a known manner, after the injection step, the injected plastic material shrinks during the removal from the mould (plastic shrinkage). It is hence expected that a biodegradable film positioned during this injection step, which does not deform (no shrinkage), will necessarily form waves during the packaging removal from the mould, due to the shrinkage of the plastic material. This effect (film deformation), which reduces the packaging functionality and aesthetic, have been shown in a comparative test illustrated in the experimental section hereinafter.

According to the invention, “biodegradable” relates to a compound, a packaging, a film, that, under the action: of biological organisms (bacteria, fungi, algae . . . ), in favourable environment conditions (temperature, humidity, light, oxygen, etc.), of humidity, oxygen and heat, may be broken down, degraded and become bioabsorbable. Generally, the result of this degradation is the formation of water, CO₂ (carbon dioxide) and/or methane, and possibly by-products (residues, new biomass), non-toxic for the environment (definition from the European Standard EN NF 13432:2001, Requirements for packaging recoverable through composting and biodegradation). This property is measured by standard and normalized tests (ISO 14855:2005: Biodegradability under controlled composting conditions). In particular, in order for a material to be considered as biodegradable, it must be able to reach 90% biodegradation in less than 6 months (Standard NF EN 13432:2001).

According to the invention, “biodegradable film” means any flat biodegradable substrate having a thickness from 10 μm to 300 μm, preferably from 10 μm to 200 μm, in particular from 30 μm to 150 μm, which may for example be in sheet form. A biodegradable film according to the invention will be described hereinafter.

In particular, the biodegradable packaging according to the invention (substrate+biodegradable film) fulfils the standard NF T51800 (2015) for home compostable plastic.

Generally, the biodegradable film has a thickness lower than or equal to 0.3 mm, preferably lower than or equal to 0.2 mm, and typically lower than or equal to 0.1 mm, whereas the biodegradable substrate (forming the bottom and the wall of the packaging) has a thickness from 0.3 mm to 2 mm, preferably from 0.5 mm to 1.5 mm, and typically from 0.6 mm to 1.3 mm.

The packaging according to the invention has hence a certain advantage with respect to many biodegradable packagings available on the market and that do not fulfil this standard NF T51800 (2015), due in particular to the fact that they are formed of a too thick film (thickness higher than 0.3 mm).

Other non-limitative and advantageous features of the packaging according to the invention, taken individually or according to all the technically possible combinations, are the following:
the biodegradable substrate is made of biodegradable agro-material, of biodegradable thermoplastic polymer or of one of their mixtures;
said biodegradable film is watertight and/or adapted to form a gas barrier;
said biodegradable film is composed of at least one cellulose-based layer, such as paper, for example kraft paper or sulfurized paper;
said biodegradable film is composed of at least one layer based on at least one resin or based on at least one biodegradable thermoplastic polymer;
said biodegradable film is a multilayer biodegradable film comprising a first layer, based on cellulose, and a second layer, based on at least one resin or based on at least one biodegradable thermoplastic polymer;
according to this embodiment, said cellulose-based layer lays at least partially on said layer based on at least one resin or based on at least one biodegradable thermoplastic polymer, which itself lays on the biodegradable substrate, preferably the second layer based on at least one resin or based on at least one biodegradable thermoplastic polymer is taken in sandwich between the biodegradable substrate and the first layer based on cellulose;
the biodegradable thermoplastic polymer suitable for composing the biodegradable film or the biodegradable substrate is selected from: poly(glycolic acid); polylactide (PLA), poly(lactic acid) (PLA) and copolymers thereof; polycaprolactone (PCL); polyhydroxyalkanoates (PHA), such as polyhydroxybutyrate (PHB) or poly(hydroxybutyrate-co-valerate) (PHBV); poly(ethylene adipate) (PEA); poly(ethylene succinate) (PES); poly(butylene succinate) (PBS); poly(butylene adipate) (PBA); poly(butylene adipate-co-terephthalate) (PBAT); poly(butylene succinate-co-adipate) (PBSA) or one of their mixtures;
the biodegradable thermoplastic polymer forming the biodegradable film is preferably a bi-oriented PLA;
the resin is selected from: polyester, silicon or one of their mixtures;
the packaging is sealable.

The invention also proposes a method for making a packaging as described hereinabove, implemented in an in-mould labelling (IML) injection device, in a mould that has a first portion and a second portion, the method comprising the following steps:

(a) placing the biodegradable film on the first portion of the mould having a wall, so that said biodegradable film covers at least partially, preferably totally, said mould wall;

(b) putting into contact the first mould portion and the second mould portion, said second mould portion having a shape that is complementary to that of the packaging; and

(c) making the injection to form the biodegradable substrate comprising openings, said biodegradable film being placed on the inner face of said biodegradable substrate so as to obturate at least said openings;

(d) recovering the packaging.

According to an embodiment, said biodegradable film includes:
a cellulose-based layer, such as paper, for example kraft paper or sulfurized paper; or
a layer based on at least one resin or based on at least one biodegradable thermoplastic polymer, such as bi-oriented PLA polymer, or one of their mixtures; or
a first layer, based on cellulose, and a second layer, based on at least one resin or based on at least one biodegradable thermoplastic polymer; the second layer being preferably taken in sandwich between the biodegradable substrate and the first cellulose layer.

Advantageously, the layer based on at least one thermoplastic polymer comprises at least one polymer selected from a PLA, such as a bi-oriented PLA, and/or the resin-based layer comprises at least one resin selected from: polyester, silicon or one of their mixtures.

In particular, the method comprises, after step (d), an additional step of:

(e) sealing said packaging in a tray heat sealer.

The invention hence also relates to the use of the above-mentioned packaging for packing, storing or also transporting foodstuffs, such as fruits, vegetables, meats and/or plants, and/or for making capsules, such as coffee capsules.

Finally, the invention relates to the use of the above-mentioned packaging for cooking foodstuffs.

Other non-limitative and advantageous features of the biodegradable packaging, the method for manufacturing the same, as well as the uses thereof, according to the invention, taken individually or according to all the technically possible combinations, are described hereinafter.

### DETAILED DESCRIPTION OF AN EXEMPLARY EMBODIMENT

The following description with respect to the appended drawings, given by way of non-limitative examples, will permit a good understanding of what the invention consists in and of how it can be implemented.

In the appended drawings:

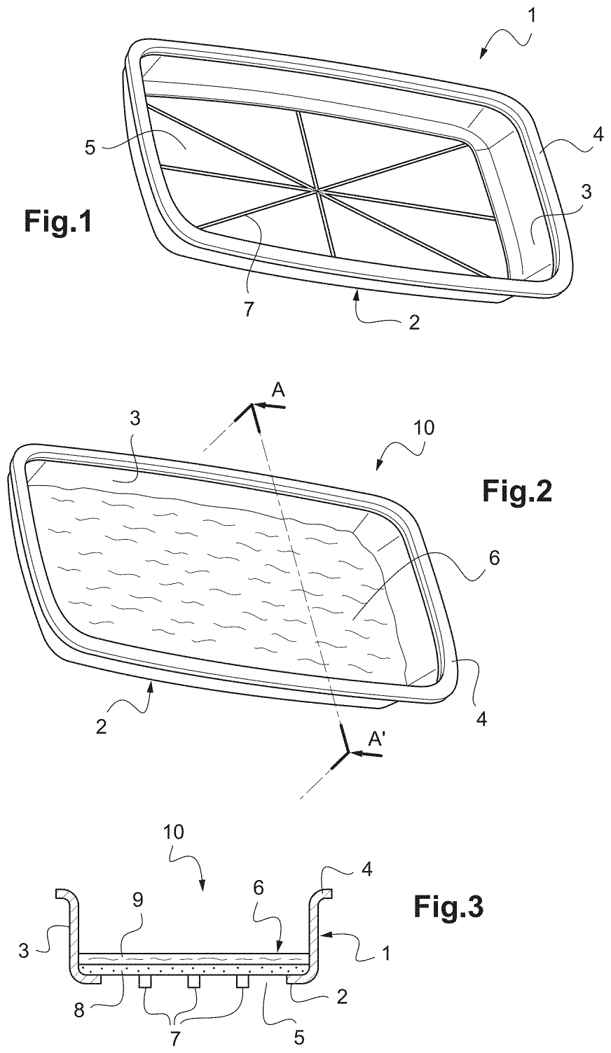

FIG. 1 is a schematic view of a packaging biodegradable substrate according to a first embodiment of the present invention in which only the bottom of the packaging comprises openings;

FIG. 2 is a schematic view of the packaging substrate illustrated in FIG. 1, further comprising a biodegradable film covering the bottom of the substrate;

FIG. 3 is a cross-sectional view taken along axis AA′ of FIG. 2, showing the position of the biodegradable film with respect to the packaging substrate;

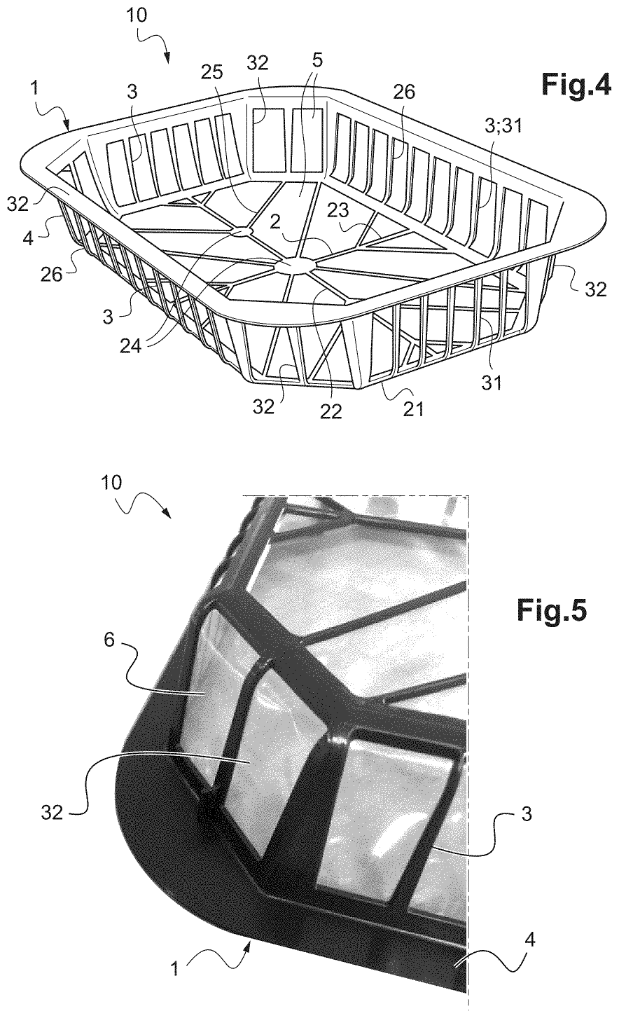

FIG. 4 is a schematic view of a packaging biodegradable substrate according to a second embodiment of the present invention in which the bottom, as well as the packaging wall, comprise openings;

FIG. 5 is a picture of the packaging according to the second embodiment illustrated in FIG. 4, showing in particular an angle of the packaging according to the invention;

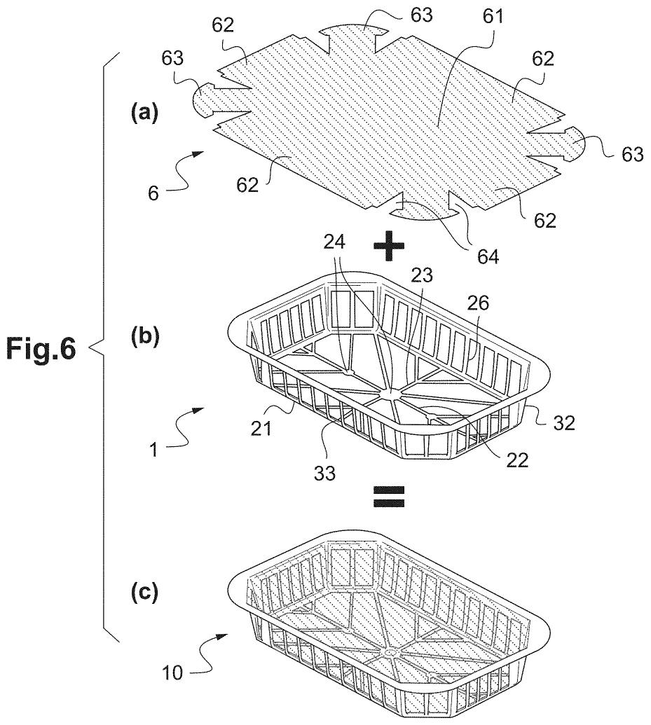

FIG. 6 is a schematic view of: (a) the biodegradable film according to the invention before being inserted into an in-mould labelling (IML) injection mould, (b) the biodegradable substrate according to the invention without the biofilm, and (c) the packaging according to the invention, i.e. comprising a biodegradable substrate whose inner surface is covered with the biodegradable film; and

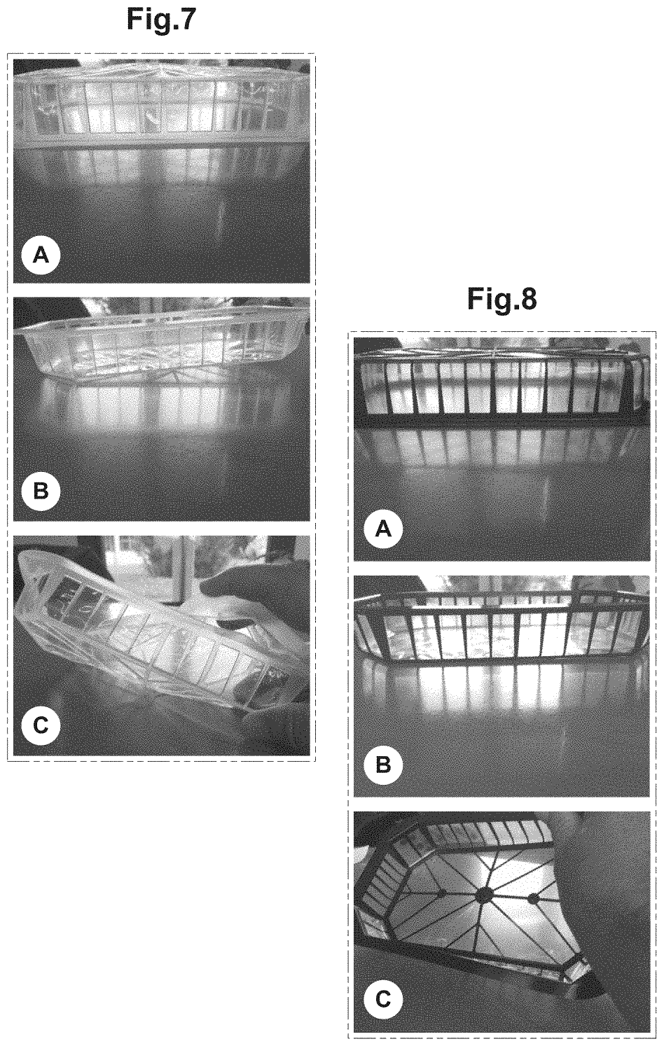

FIGS. 7 (a) to (c) are pictures showing a “control” packaging made according to the in-mould labelling (IML) technique, the control packaging comprises a substrate including openings and a film that conforms the inner surface of the substrate so as to obturate the openings, the substrate and the film are made of polypropylene (PP);

FIGS. 8 (a) to (c) are pictures showing a packaging according to the invention, made according to the in-mould labelling technique, the packaging according to the invention having the same structure as the control packaging of FIG. 7, except that the substrate, as well as the film, are made of PLA.

Referring to FIGS. 1 to 6, a packaging 10 according to the invention will be described.

This packaging 10 is particularly suitable for packing, storing foodstuffs (fresh, freeze-dried or frozen) or for cooking such foodstuffs directly in the packaging 10. The packaging 10 may also be useful in the field of agriculture for preparing and packing plants to make flowerpots, for example.

As mentioned hereinabove, the packaging 10 first comprises a biodegradable substrate 1 comprising a bottom 2 from the edge of which a wall 3 rises, so as to define an inner face. Hence, this inner face corresponds to the surface of the bottom 2 and to the surface of the lateral wall 3 directed towards the inside of the packaging 10. This inner face itself delimits the inner space of the packaging 10 adapted to receive an item, such as a foodstuff or a plant. Generally, the wall 3 is slightly flared.

The wall 3 is preferably ended by an edge 4. This edge 4 may serve, for example, as a support for closing the packaging 10 with a suitable material as a function of the desired use for said packaging (cooking, etc.).

Preferably, the packaging 10 is sealable and a film (not shown in the figures) is adapted to be heat-sealed on the edge 4 so as to close/open, generally tightly, the inner space of the packaging 10. Indeed, the biodegradable substrate 1 is rigid enough to support a step of sealing this film in a heat sealer. In particular, it is adapted to support a pressure from 0 bar to 3 bar, preferably from 0.5 bar to 2.5 bar, and typically from 0.7 bar to 2.2 bar. Such a film adapted to be heat-sealed is well known from the one skilled in the art; it is for example conventionally used in the field of food trays (prepared dishes) and may, for example, correspond to a film made of polypropylene (PP). Preferably, the film closing the inner space of the packaging 10 according to the invention is also biodegradable.

Generally, the biodegradable substrate 1 has hence the shape of a tray.

According to the invention, this biodegradable substrate 1 comprises one or several openings 5. These openings 5 or recessed areas make it possible in particular to reduce the weight of the packaging 10.

According to a first embodiment illustrated in FIGS. 1 to 3, it can be seen that only the bottom 2 has openings 5. However, according to a second embodiment illustrated in particular in FIGS. 4 to 6, the openings 5 may be arranged both in the lateral wall 3 and in the bottom 2.

As an alternative, it may be provided that only the wall 3 comprises the openings 5.

Generally, the packaging according to the invention will have one or several openings 5 both in the bottom 2 and in the lateral wall 3.

According to a feature of the invention, the surface occupied by the opening(s) 5 with respect to the total surface of the inner face of the packaging 10 varies from 1 to 99%, preferably from 50 to 99%, and typically from 70 to 99%. Indeed, according to the invention, the inner surface of the packaging 10 may be mainly composed of the openings 5. A very lightweight packaging also having good mechanical properties is hence obtained.

According to the invention, a range of values varying from 1 to 99% includes the following values or any interval between these values: 1; 2; 3; 4; 5; 6; 7; 8; 9; 10; 11; 12; 13; 14; 15; 16; 17; 18; 19; 20; 25; 30; 35; 40; 45; 50; 55; 60; 65; 70; 75; 80; 85; 86; 87; 88; 89; 90; 91; 92; 93; 94; 95; 96; 97; 98; 99.

Generally, when there are several openings 5, these latter are uniformly distributed over the substrate 1.

According to a particular embodiment shown in FIG. 4, the biodegradable substrate 1 may be in the form of a symmetrical openwork structure or a symmetrical frame still having a bottom 2 and a wall 3. In particular, the bottom 2 is formed of a longitudinal rod 22 and a transverse rod 23, which are connected to a peripheral edge 21. The bottom 2 also includes “V-shaped” rods 25 that extend from the longitudinal rod 22 or the transverse rod 23. The bottom 2 may also comprise at least one reinforcement disk 24 (herein 3 in number) at the junctions between the V-shaped rods and the longitudinal rod 22. The openings 5 present in the bottom 2 are hence created between the different rods 21, 22 and 25 and the edge 21. The wall 3 extends from the peripheral edge 21 to the edge 4 of the packaging and comprises several vertical pillars 26 that connect these two edges 21 and 4. The openings 5 of the wall 3 are hence created between the different pillars 26. Moreover, the “V-shaped” rods 25 met up the peripheral edge 21 of the bottom 2 and end up at two vertical pillars 26. This structure has for advantage to have many openings 5, while keeping good mechanical properties.

In order to reinforce the mechanical properties of the packaging and to guarantee the functionality thereof, the packaging 10 also includes a biodegradable film 6 that is adapted to conform the inner face of the biodegradable substrate so as to obturate at least all the openings 5.

By “a film”, it is meant that the film 6 is unique, i.e. there is only one film that covers all the openings 5 that may be present in the bottom 2 and/or the wall 3 of the substrate 1. However, as described hereinafter, this film 6 may be single-layer or multilayer.

Preferably, the biodegradable film 6 covers both the bottom 2 and the inner face of the wall 3 of the biodegradable substrate 1, in other words the biodegradable film covers the whole inner face of the biodegradable substrate 1.

A packaging that may be watertight and adapted to form a gas barrier, such as to oxygen, is hence obtained.

Preferably, the biodegradable substrate 1 is made of biodegradable agro-material, of biodegradable thermoplastic polymer or of one of their mixtures;

According to a first embodiment, the biodegradable substrate 1 is hence made of agro-material.

By “agro-material”, it is meant a material that is mainly composed of raw materials of agricultural origin. In particular, natural fibres and biopolymers (starch, cellulose . . . ) or synthetic polymers.

Generally, the biodegradable agro-material may be composed of fibres, starch and possibly an adjuvant (as, for example, PLA (polylactic acid) or biodegradable polyesters).

The agro-material used herein is preferentially composed of more than 90% (on dry matter) of compounds derived from agro-resources, i.e. compounds such as, for example, starch, flours, fibres, biodegradable polyesters, etc. The proportion of these compounds derived from agro-resources may even be preferably of 100%, but it may also contain compounds such as colouring agents, for example, which are not derived from agro-resources.

Generally, the biodegradable substrate 1 has, according to the International Standard ISO 527 (2012), a tensile modulus of at least 600 N/mm². According to the present invention, a tensile modulus measured according to the International Standard ISO 527 of at least 600 N/mm² comprises the following values or any interval comprised between these values: 1500; 1550; 1600; 1650; 1700; 1750; 1800; 1850; 1900; 1950; 2000; 2100; 2200; 2300; 2400; 2500; 3000; 3500; 4000; etc.

The biodegradable substrate 1 according to the present invention may have a flexural strength, measured as described in the standard NF EN 310 (1993), of at least 20 N/mm² and, preferably, of at least 25 N/mm², and a flexural modulus of at least 1500 N/mm².

According to the invention, a flexural strength of at least 20 N/mm² comprises the following values or any interval comprised between these values: 21; 22; 23; 24; 25; 26; 27; 28; 29; 30; 31; 32; 33; 34; 35; 36; 37; 38; 39; 40; 41; 42; 43; 44; 45; 46; 47; 48; 49; 50; 51; 52; 53; 54; 55; etc.

Generally, the biodegradable substrate is made of an agro-material selected from: polysaccharides (such as potato, corn, wheat or rice starches), proteins (such as casein, collagen, gelatin, gluten), or one of their mixtures.

By way of example, the biodegradable agro-material suitable for making the biodegradable substrate 1 according to the invention may be obtained from granulates, comprising at least (the percentages being expressed in weight with respect to the total weight of dry matter):
20% to 60% of starch;
3% to 20% of proteins;
15% to 60% of cellulose, hemicellulose and lignin;
1% to 15% of lipids, and
0.01% to 10% of sugars.

Such an agro-material in the form of granulates may be for example obtained according to the method mentioned in document FR 2 783 740.

In particular, the method of preparing these granulates based on a plant material derived from at least one cereal plant comprises the following steps:
a) cutting all the aerial parts of the plant, or a substantial fraction of these latter, into fragments,
b) crushing, or shearing, the fragments until obtaining granulates having an average size comprised between about 0.01 and 10 mm, preferably from 0.5 to 1 mm;
c) adjusting the water content of the granulates until reaching a whole moisture content comprised between 10 and 35%.

If the residual moisture content of the fragments obtained at the end of step a) is too high, said fragments may be dried until reaching a residual moisture content comprised between about 5 and 20%, preferably from 7 to 13%. By “aerial part of the plant”, it is meant the stems, leaves, stalks, grains, spathes, but also any other aerial part that may exist, as a function of the vegetable species and varieties.

The vegetable material is preferably derived from at least one cereal plant. It can nevertheless also comprise material derived from one or several non-cereal plants.

The cereal plants that may be used for implementing this method may be any cereal plant whose grains contain a sufficient quantity of starch, preferably at least 20% of starch in weight of the whole plant. In particular, they may be corn, durum wheat, common wheat, sorghum, oat, rye and rice.

The above-mentioned step (a) may be implemented using either all the aerial parts of the previously isolated plant, or a substantial fraction of these isolated aerial parts. It is meant by “substantial fraction” at least 80% in weight of the aerial parts of the plant. It may also be implemented using aerial parts of plants belonging to different varieties, or species.

Moreover, small quantities of additives may, if necessary, be added to any one of the steps of the above-mentioned method.

As used herein, the size of the granulates is measured by making the granulates pass through screens of decreasing mesh diameters. By way of example, granulates having a size comprised between 0.5 and 1 mm pass through meshes of 1 mm diameter, but do not pass through meshes of 0.5 mm diameter.

Step b) of crushing or shearing may be implemented by means of a hammer mill equipped with grids having suitable mesh diameters. It may also be implemented by means of any other device known by the one skilled in the art and providing equivalent results.

Such granulates, having potentially undergone an extrusion, have a behaviour comparable to that of a thermoplastic material and may then be injected into a mould. The use of such granulates is perfectly comparable to that of the synthetic plastic materials, such as polyethylene, polypropylene and polystyrene.

By way of non-limitative example, materials such as those obtained by implementing the methods described in the examples 1 to 4 of document FR 2 783 740 may be used.

According to a second embodiment, the biodegradable substrate 1 may be made of at least one biodegradable thermoplastic polymer.

The biodegradable thermoplastic polymer suitable for forming the biodegradable substrate 1 may be selected from a biodegradable polyester, such as poly(glycolic acid); polylactide (PLA), poly(lactic acid) (PLA) and copolymers thereof; polycaprolactone (PCL); polyhydroxyalkanoates (PHA), such as polyhydroxybutyrate (PHB) or poly(hydroxybutyrate-co-valerate) (PHBV); poly(ethylene adipate) (PEA); poly(ethylene succinate) (PES); poly(butylene succinate) (PBS); poly(butylene adipate) (PBA); poly(butylene adipate-co-terephthalate) (PBAT); poly(butylene succinate-co-adipate) (PBSA) or one of their mixtures.

Generally, according to this embodiment, the biodegradable substrate 1 is made of PLA.

PLA is a linear thermoplastic aliphatic polyester; it is produced by several techniques, in particular azeotropic condensation, direct condensation polymerization, or polymerization through lactide formation (ring-opening), the most used at the industrial scale. Due to the chiral nature of the lactic acid, the PLA stereochemistry is complex. As lactic acid exists in two stereoisomer forms, the dimer obtained from two lactic acids may appear in three different enantiomeric forms. Subsequently, PLA may exist in three stereochemical forms: poly(L-lactide) (PLLA), poly(D-lactide) (PDLA), and poly(DL-lactide) (PDLLA).

The L-lactide and D-lactide copolymers show a lower crystallization than that of the L-lactide homopolymers, so the variation of the L/D ratio produces PLA with different properties. Generally, a high stereochemical purity (higher L-) favours the material crystallization, those which are rich in isomers D (15%) are amorphous. PLA has a crystallinity of about 37%, a glass transition temperature between 50 and 80° C. and a melting point between 173 and 178° C.

PLA is easily degraded in an industrial compost within 3 months, or even 6 months maximum, contrary to conventional plastics, such as PE (polyethylene) and PS (polystyrene) (between 500 and 1000 years). The polymer degradation mainly occurs by splitting of the main chains or the lateral chains of the macromolecules. It is generally induced by heat activation, hydrolysis, biological activity (enzymes), oxidation, photolysis or radiolysis.

Generally, the biodegradable substrate 1 according to the invention resists to temperatures up to 160° C., in particular up to 150° C. and typically up to 120° C., for example comprised between −30° C. and 110° C.

According to the invention, a temperature up to 160° C. comprises at least the following temperatures or any interval comprised between these latter: −30° C.; −20° C.; −10° C.; −5° C.; 0° C.; 20° C.; 50° C.; 60° C.; 70° C.; 80° C.; 90° C.; 100° C.; 110° C.; 120° C.; 130° C.; 140° C.; 150° C.; 160° C.

Of course, the biodegradable substrate 1 may be made of a mixture of an agro-material described hereinabove with one or several of the above-mentioned thermoplastic polymers.

According to the invention, the thickness of the biodegradable substrate 1 will depend on the desired use for the packaging 10. As a function of the desired mechanical strength, the biodegradable substrate 1 will have a greater or lesser thickness.

In the field of packaging, a thickness of the order of one millimetre or a few millimetres may for example be provided.

As mentioned hereinabove, the biodegradable substrate 1 is covered, and in particular at least at some or all of the openings 5, by a biodegradable film 6.

According to a first embodiment, the biodegradable film 6 comprises a single cellulose-based layer.

Preferably, the cellulose-based layer corresponds to paper such as kraft paper, sulfurized paper, filter paper, non-woven, cotton or one of their combinations. Typically, the cellulose layer is made of kraft paper and/or sulfurized paper.

Generally, the cellulose-based layer has a burst strength from 0.2 to 3 kg/cm².

In particular, the kraft paper has the advantage to be very resistant. It is obtained with soda-treated wood-based pulps. The wood generally used is a resinous wood, of the pine or fir type.

The paper used herein may have different grammages as a function of the use which is made of the multilayer material. By way of non-limitative example, the kraft paper used has a grammage comprised between 40 and 180 g/m².

According to this embodiment, the cellulose layer may have a thickness from 10 to 200 μm, preferably from 30 to 150 μm.

By way of example, the kraft paper marketed by the LEIPA Company under the reference VKP80 is suitable as a paper membrane according to the present invention.

According to a second embodiment, the biodegradable film 6 comprises a single layer based on a resin or based on at least one biodegradable thermoplastic polymer.

According to a first feature of this embodiment, the film may correspond to a single layer based on at least one resin.

The term “resin” is used herein in its wide sense and herein denotes a solid, semi-solid or pseudo-solid organic material, that tends to flow when submitted to a constraint.

In particular, the resin layer may, for example, also be made of polyester(s), silicon or one of their mixtures.

By way of example, the polyester(s) suitable for making the resin layer may generally be selected from: poly(butylene adipate-co-terephthalate) (PBAT), poly(butylene succinate-co-adipate) (PBSA), poly(butylene succinate-co-lactide) (BPSL), poly(butylene succinate-co-terephthalate) (PBST), poly(butylene succinate) (PBS), polymers derived from lactic acids (PLA), polycaprolactones (PCL), polyesteramines (PEA), polyglycolide (PGA), poly(methylene adipate-co-terephthalate) (PTMAT), vinylic alcohol polymer, polyhydroxyalkanoate (PHA) or one of their mixtures.

A resin suitable for the present invention may be in particular the resin marketed under the registered trademark NatureFlex® and marketed by the Futamura Company.

It may also be mentioned herein, by way of non-limitative example, the use of a biodegradable film as described in document WO-2009/024812, for making the resin layer.

According to a second feature of this embodiment, the film 6 may correspond to a single layer based on at least one biodegradable thermoplastic polymer.

Generally, the biodegradable thermoplastic polymer is selected from a biopolymer, a polyester, or one of their mixtures.

A polymer is said “biodegradable” according to the invention when it may be broken down by biological organisms (bacteria, fungi, algae . . . ) in favourable environment conditions (temperature, humidity, light, oxygen, etc.). Hence, a biodegradable polymer may be derived from renewable resources (polyhydroxyalkanoates, starch, etc.) or from non-renewable resources such as polycaprolactone (aliphatic polyester).

On the one hand, the biodegradable thermoplastic polymer according to the invention may be selected from a biopolymer, i.e. a polymer extracted from the biomass.

A biopolymer suitable for the present invention may be:
a polysaccharide (potato, corn, wheat or rice starch; lignocellulosic: wood, straw; others: chitin),
a protein, such as casein, collagen, gelatin, gluten, zein,
or one of their mixtures.

On the other hand, the biodegradable thermoplastic polymer according to the invention may be selected from a biodegradable polyester obtained for example from microorganisms (by extraction), by conventional synthesis from biomonomers.

A biodegradable thermoplastic polyester suitable within the framework of the present invention may be selected from: poly(glycolic acid); polylactide (PLA), poly(lactic acid) (PLA) and copolymers thereof; polycaprolactone (PCL); polyhydroxyalkanoates (PHA), such as polyhydroxybutyrate (PHB) or poly(hydroxybutyrate-co-valerate) (PHBV); poly(ethylene adipate) (PEA); poly(ethylene succinate) (PES); poly(butylene succinate) (PBS); poly(butylene adipate) (PBA); poly(butylene adipate-co-terephthalate) (PBAT); poly(butylene succinate-co-adipate) (PBSA) or one of their mixtures.

Typically, the biodegradable thermoplastic polymer is the polylactide (PLA) and, in particular, a bi-oriented PLA. The bi-oriented PLA has generally thermal properties with respect to a conventional PLA (non-oriented).

Such a bi-oriented PLA (bi-axial orientation) is in particular distinct from a conventional PLA in that it is double-stretched. It may be manufactured as follows: longitudinal stretching during the in-line extrusion, then transverse stretching after it has been taken back. Such a bi-oriented PLA may for example be marketed by the TAGHLEEF Company, under the reference D808 or D813.

Preferably, the thermoplastic polyester suitable for forming the packaging 10 according to the invention will be polylactide, poly(lactic acid) (PLA) and one of their copolymers, or also a mixture of polylactide/poly(lactic acid) (PLA) and the copolymers thereof with a polyhydroxyalkanoate (PHA).

According to a third embodiment and with reference to FIG. 3, the biodegradable film 6 is a multiplayer and may comprise in particular a first cellulose-based layer 9 as described hereinabove and a second layer 8 based on resin or on at least one biodegradable thermoplastic polymer, also as described hereinabove.

According to a first feature of this embodiment, the second layer 8 made of resin or biodegradable thermoplastic polymer is generally positioned between the biodegradable substrate 1 and the first cellulose-based layer 9. Generally, the lower face of the biodegradable substrate 1 (bottom and/or wall) is partly, and generally fully, covered (direct contact) by the layer 8 made of resin or biodegradable thermoplastic polymer, which is itself partly, and generally fully, covered (direct contact) by the cellulose layer 9 (FIG. 3).

By way of example, the first layer 9 may be made of sulfurized paper and the second layer 8 of PLA.

According to a second feature of this embodiment, it is possible that this is the cellulose-based layer 9 that is taken “in sandwich” between the biodegradable substrate 1 and the second layer 8 made of resin or biodegradable polymer. In particular, the lower face of the biodegradable substrate 1 (bottom and/or wall) is partly, and generally fully, covered (direct contact) by the cellulose layer 9, which is itself partly, and generally fully, covered (direct contact) by the layer made of resin or biodegradable thermoplastic polymer 8.

In this case, the first layer may be made of kraft paper and the second layer may be based on silicone.

Indeed, the Applicant has discovered that the first cellulose layer 9 was able to adhere perfectly to the biodegradable substrate 1, such as the agro-material biodegradable substrate.

However, the use of a second layer 8 made of resin or thermoplastic layer between the biodegradable substrate 1 and the cellulose layer 9 generally makes it possible to improve the performances of the biodegradable substrate 1 by making it, for example, watertight and adapted to form a gas barrier, which may be useful for storing meat, cheese, for example, or cooked dishes. This type of film 6 may be siliconized paper.

The second layer 8, whether it is made of thermoplastic polymer or resin, serves in particular to reinforce the cellulose-based layer 9. That is why, when present, it is applied on the latter at the rate of 5 g/m², preferably at least 10 g/m², in particular 12 to 25 g/m² and typically 15 to 20 g/m².

In the sense of the invention, at least 5 g/m² includes the following values: 5, 6, 7, 8, 9, 10, 11, 12, 13, 14, 15, 16, 17, 18, 19, 20, 21, 22, 23, 24, 25, etc.

It has a thickness generally going from 5 μm to 40 μm, typically from 10 μm to 30 μm.

The second layer 8 according to the invention is hence biodegradable and adapted to heat-seal, heat-weld, the cellulose-based membrane 9 to the biodegradable substrate 1.

Advantageously, the first layer 9 may be made of sulfurized paper and the second layer 8 is made of PLA. Such a biodegradable film 6 may correspond to the product marketed by the Ahlstrom Company, under the name “top lid O2 barrier for espresso”, ref.: SS5961092. Moreover, the first layer 9 may be made of kraft paper or white paper and the second layer 8 is made of silicone. Such a biodegradable film may correspond to a biodegradable film marketed by the MONDY Company, under the name “Advantage bakery release 1 sC White”.

Possibly, the thermoplastic polymer and/or the resin of the biodegradable film 6 according to the invention may be added with additives.

These additives may be:
anti-static agents that make it possible, in particular, to avoid the deposition of dust by making the formed thermoplastic material surface conductive (ethoxylated fatty amines, polyhydroxylated polyols are suitable as the additive according to the invention);
shock-absorbing agent (acrylics, etc.);
lubricants in order to facilitate the implementation by favouring the sliding (such as waxes, calcium stearate . . . );
colouring agents/pigments, such as pigments insoluble in the polymer (carbon black, metal oxides . . . ) and organic colouring agents soluble in the polymer;
plasticizers, in order to make the plastic more flexible, more resilient with a lower glass transition temperature (such as sorbitol, polyethylene glycol, glycerol, fatty acid esters, etc.);
fillers making it possible to reduce the cost of the thermoplastic material, to improve mechanical properties, to obtain a better heat resistance, etc., such as the fillers of mineral origin (calcium carbonate, silica, talc, clay, carbon black . . . ), the organic fillers (wood flour, cellulose, starch, cereals . . . ), the metallic fillers making it possible to provide the matrix with a conductive character (aluminium, copper, zinc . . . ), and the fibrous fillers (glass fibres, hemp fibres, linen fibres . . . );
an additive making it possible to improve the elongation at break and the shock reinforcement of a thermoplastic polymer material, and in particular a material based on biodegradable breakable polymers, such as poly(lactic acid) as a lipidic additive;
or any other constituent usable with the thermoplastic polymers, and that in the quantities usually used in the state of the art and known from the one skilled in the art.

These other additives are present to the amount of 0 to 59.5%, preferably from 10% to 50% in mass with respect to the total mass of said thermoplastic material.

In particular, the fillers may represent, by way of example, 40% in mass with respect to the total mass of the thermoplastic material. In particular, the biodegradable film 6 will be adapted as a function of the desired use for the packaging.

Generally, the biodegradable film 6 has a constraint, according to the International Standard ISO 527 (2012), going respectively from 40 MPa to 400 MPa, preferably from 45 to 350 MPa, and in particular from 50 to 300 MPa, and typically from 55 to 200 MPa.

Generally, the film 6 according to the invention resists to temperatures up to 160° C., and typically up to 130° C., for example comprised between −30° C. and 120° C.

Hence, the biodegradable film 6 or the biodegradable substrate 1 described herein is biodegradable according to the Standard NF EN 13432 (November 2000).

The biodegradable packaging 10 according to the invention is hence generally fully recyclable through composting.

Moreover, the biodegradable packaging according to the invention is adapted to be heated in an oven or a microwave over (microwavable packaging) and resists, for example, to temperatures up to 130° C., preferably up to 120° C., and more particularly from −30° C. to 120° C., for example from −10° C. to 110° C.

Preferably, the packaging 10 according to the invention has a cylindrical shape of varied cross-section that is itself defined by the shape (contour) of the bottom 2. The bottom 2 may have various shapes, including a polygonal shape (at least three rectilinear edges connected by apices) or a non-polygonal shape (at least one curved edge, for example round, oval).

Generally and as shown in FIGS. 4 to 6, the bottom 2 has a polygonal shape, for example triangular, square or also rectangular, etc., and hence comprises angles that themselves define angle areas 32 (area where the direction of the wall 3 changes) on the inner face of the packaging 10, connected between each other by the lateral walls 31.

According to the present invention, the angles present in the bottom 2 do not form, preferably, a right angle, or are substantially not at right angle. On the contrary, the angles are rounded, chamfered or bevelled (obliquely cut edge). Hence, the angle areas 32 of the packaging 10 are generally rounded or cut-off corners.

Hence, according to this feature, the angle areas 32 are generally mainly formed by the biodegradable film 6, i.e. the later covers at least 60%, preferably at least 80%, and generally at least 90% of the surface of the angle areas 32, in particular when these angle areas 32 comprise openings 5. In this case, the biodegradable substrate at the angle areas mainly serves to give the wall 3 its direction.

According to the invention, by at least 60%, it is meant the following values (in percentage) or any intervals comprised between these values: 60; 65; 70; 75; 80; 81; 82; 83; 84; 85; 86; 87; 88; 89; 90; 91; 92; 93; 94; 95; 96; 97; 98; 99; etc.

The feature has normally for advantage to facilitate the removal from the mould during the making of the packaging 10 (no undercut that would make the mould more complex).

However, the edge 4 forms for its part a substantially right angle, with adding of material at these angles so as to allow a film to be heat sealed thereto (sealing).

Generally, the biodegradable film 6 is positioned on the biodegradable substrate 1 by the in-mould labelling (IML) technique.

To make a multi-layer material according to the present invention, it is proposed to use a method of the in-mould labelling type, nevertheless with adaptations.

The in-mould labelling method consists in applying a label made of synthetic material into an injection tool during the manufacturing of a packaging, also made of synthetic material. It is not usual at all to use such a method with paper or a cellulosic film. Moreover, when the matter is labelling, the label is of course stuck on the outer face of the packaging to be visible to the consumer.

The present invention originally proposes to use a method derived from the IML method.

The present invention hence relates to a method for making a packaging 10 as described hereinabove, implemented in an in-mould labelling (IML) injection device having a mould.

In particular, the mould of the IML device has a first portion, generally fixed, and a second portion, which is positioned opposite the first portion, and which is generally mobile. In particular, the shape of the first portion corresponds to the inner face of the desired packaging 10, whereas the shape of the second portion has a shape that is complementary to that of the desired packaging 10.

The method according to the invention comprises the following steps:

(a) placing on the first portion of the mould having a wall, the biodegradable film 6 that is generally in the form of a pre-cut flat film, so that said biodegradable film 6 covers at least partially said mould wall;

(b) putting into contact the first mould portion and the second mould portion, and

(c) making the injection to form the biodegradable substrate 1 comprising openings 5, said biodegradable film 6 being placed on the inner face of said biodegradable substrate 1 so as to obturate at least said openings 5,

(d) recovering the packaging (removal from the mould).

Of course, the features of the packaging 10 are also valid for describing the method according to the invention. Insofar as they have already been described hereinabove, they won't be described in more detail hereinafter.

Hence, said biodegradable film 6 is as described hereinabove.

For example, when the film 6 is multilayer and comprises a layer 8 of resin or thermoplastic polymer that is taken in sandwich between the substrate 1 and the cellulose-based layer 9. In this case, generally, during step (a), the cellulose-based layer is placed against the wall of the first mould portion.

As an alternative, as a function of the desired packaging, it is possible that this is the resin layer or the biodegradable thermoplastic polymer layer that is placed against the wall of the first mould portion.

When the film 6 is single-layer, it is simply placed against the wall of the first mould portion.

Hence, contrary to an IML method traditionally used, the biodegradable film 6 is deposited on the wall of the first mould portion corresponding to the inner face of the desired packaging as a function of the number and the location of the openings 5.

Once the first mould portion lined with layer(s) forming the film 6, the material forming the biodegradable substrate 1, such as the agro-material, is injected into the IML device (mould) by a conventional injection method, known from the one skilled in the art and not described in detail herein.

A packaging according to the invention is hence obtained, with an excellent connection between the biodegradable substrate 1 based on agro-material and the cellulose-based layer or, as the case may be, the biodegradable substrate 1 based on agro-material and the resin layer or the biodegradable polymer layer.

In particular, during step (a), the biodegradable film 6 is generally in a pre-cut form.

According to the embodiment shown in FIG. 6, the biodegradable film 6 may be pre-cut to form a packaging with cut-off angle areas 32 connected to each other by lateral walls 33.

According to this embodiment, the pre-cut biodegradable film 6 comprises a central portion 61 that will form the bottom 2 of the packaging 10 during the step (d) of recovering (removing from the mould). This central portion 61 is extended, on the one hand, by lateral flaps 62, four in number if the bottom 2 of the packaging is square or rectangular. These lateral flaps 62 have a generally rectangular aspect and will be folded over during the injection step (c), so as to form the lateral walls 31. On the other hand, the central portion 61 is also extended by angle flaps 63, also four in number if the bottom 2 of the packaging is square or rectangular. These angle flaps 63 have also a generally rectangular aspect and will be folded over during the injection step (c) in order to form the angle areas 32. In particular, the angle flaps 63 and the lateral flaps 62 are separated by “V-shaped” cuts 64. Typically, the angle flaps 63 are arranged between two lateral flaps 62 and between two “V-shaped” cuts 64. Complementary cuts may also be provided on the lateral and/or angle flaps so that the film 6 conforms accurately the inner face of the packaging 10 after removal from the mould. These different cuts avoid in particular the excesses of material during the injection step.

Steps (b) to (d) are the conventional steps of an IML injection and are well known of the one skilled in the art.

Indeed, step (b) of putting into contact is performed by automatic deposition with electrostatic charge or suction. For example, the POLYFLEX robot marketed by Machines Pages suits for the method according to the invention.

Step (c) of injecting the material(s) able to form the biodegradable substrate 1 (agro-material, resin, biodegradable polymer) is performed for example at a speed from 10 to 200 mm/sec. This or these materials have been previously plasticized, i.e. heated to a plasticizing temperature from 120 to 230° C. Then, a pressure from 500 bar to 2400 bar is exerted between the two mould portions and the whole is heated to a temperature from 150° C. to 220° C., and preferably from 160° C. to 210° C. In particular, the duration of the cycle is comprised between 2 and 20 sec. During this step, the pre-cut film of step (a) conforms perfectly the shape of the mould and is welded to the injected material(s) forming the biodegradable substrate 1. Hence, the film 6 adheres and is stuck to the inner face of the biodegradable substrate 1.

It has been surprisingly noticed that the biodegradable substrate 1, once injected and cured, had a very low shrinkage rate and in particular lower than or equal to 1%, preferably lower than or equal to 0.8%, and typically lower than or equal to 0.5%. By “shrinkage rate lower than or equal to 1%”, it is meant the following values or any interval comprised between these values: 1; 0.9; 0.8; 0.7; 0.6; 0.5; 0.4; 0.3; 0.2; 0.1; 0.09; 0.08; 0.07; 0.06; 0.05; 0.04; 0.03; 0.02; 0.01; etc. The shrinkage rate is generally measured according to the Standard ISO 294-4:2001.

For a packaging, it is preferable to provide a labelling and/or a decoration. It is hence possible to add on the cellulose layer 9 a new complex, formed for example of a cellulosic film and a paper sheet, to decorate and/or to label the packaging.

The so-obtained multilayer allows forming a gas barrier and obtaining a good water tightness.

The present invention also relates to the use of the packaging described hereinabove:
for packing, storing or also transporting foodstuffs, such as fruits, vegetables, meat and/or plants, and/or for making capsules, such as coffee capsules;
for cooking foodstuffs.

Of course, the uses according to the invention have the same features as those described hereinabove for the packaging or for the packaging manufacturing method. Insofar as they have already been described, they won't be described in more detail hereinafter.

Hence, the packaging 10 is well adapted to the making of packagings, in particular in the field of food, but other uses may be contemplated.

### EXAMPLE

A comparative packaging (FIG. 7 (a) to (c)) comprising: a non-biodegradable plastic substrate made of polypropylene (PP) and a plastic film also made of PP has been manufactured according to the method of the invention (IML method). The PP is currently used to make trays for food dishes. Moreover, the comparative packaging comprises many openings, whether it is on the bottom or on the wall, in accordance with the features of the packaging according to the invention.

A packaging according to the invention ((FIG. 7 (a) to (c)) comprising a biodegradable substrate made of PLA is a biodegradable film made of PLA has also been made according the method of the invention.

A) General Procedure

Raw Materials

| Material/Equipment | Reference, Feature, Provider |
|---|---|
| Substrate made of polypropylene | Ref RJ470MO, from Borealis |
| PP (control) | |
| Film made of polypropylene | PP 40 microns, from TREOFAN |
| (control) | |
| Biodegradable substrate | PLA of average molecular weight |
| (invention) | M_{w} between 1.10⁴ and 1.10⁵, from |
| | NatureWorks ® Ingeo ™ 3251D |
| PLA film (invention) | INFIANA ®, thickness 40 microns, |
| | Reference 75423 |
| Injection machine | Press for injecting thermoplastics, |
| | type Arburg, NETSTAL, DEMAG |
| | The mould has a first portion and a |
| | second portion, the second mould |
| | portion having a structure that is |
| | complementary of that of the |
| | substrate shown in FIG. 4. |

Implementation Method

The following method has been implemented to make the two above-mentioned packagings:
a PP film (comparative example) and a PLA film have been cut so as to have the shape illustrated in FIG. 6(a);
this PP or PLA film has then been placed in the first portion of an IML mould having a wall so that the film covers the mould wall;
the first mould portion and the second mould portion have been put into contact (closing and locking phase during an automatic cycle of thermoplastic injection);
the injection of the material forming the substrate (wherein the latter has been previously plasticized at temperatures from 170 to 200° C. for the PLA material according to the invention and from 180 to 220° C. for the comparative PP material) is then performed at a speed of 75 mm/sec, then 65 mm/sec and finally 55 mm/sec, with a pressure of 2000 bar for the PLA material and 1300 bar for the PP material, the cycle duration is of 8 seconds, so as to obtain a PLA substrate (invention) and a PP substrate (comparative example) comprising openings as illustrated in FIGS. 4 to 8; during this step, the PLA film according to the invention or PP film according to the comparative example will conform the inner surface of the PLE or PP substrate, respectively, so as to obturate the openings;
the so-formed packaging is recovered.
B) Results

As shown in the pictures of FIG. 7, the comparative packaging according to the invention, for an identical structure (the PP substrate has the same shape/frame as the PLA substrate according to the invention), does not have good mechanical properties: the structure is easily deformed by simple manual pressure (FIG. 7(a)) (no stiffness, the structure does not keep its shape and cannot serve to contain containers), contrary to the structure of the invention that remains rigid under the pressure exerted (FIG. 8(c)).

Moreover, the PP film forms waves (FIG. 7 (a) (b)). This is in particular due to the high shrinkage rate of the PP substrate after injection, whereas the PP film does not shrink. On the contrary, the PLA film according to the invention forms no wave (the film remains stretched) on the PLA substrate according to the invention (FIG. 8 (a) (b)), which does not shrink or a very little, as shown in the Table hereinafter.

| | Shrinkage Rate measured according |
|---|---|
| Examples | to Standard ISO 294-4: 2001 |
| Comparative packaging | 2.0% |
| Packaging according to the | 0.3% |
| invention | |

1-15. (canceled)

16. A biodegradable packaging (10) comprising:
a biodegradable substrate (1) comprising a bottom (2) from the edge of which a wall (3) rises, so as to define an inner face adapted to contain an item;
a biodegradable film (6),
wherein said biodegradable substrate (1) comprises one or several openings (5) arranged in the bottom (2) and/or the wall (3), said biodegradable film (6) being positioned on said inner face of said biodegradable substrate (1) so as to obturate at least said openings (5) and wherein the biodegradable film (6) is positioned on the biodegradable substrate (1) by the in-mould labelling technique.

17. The packaging according to claim 16, wherein the biodegradable substrate (1) is made of biodegradable agro-material, of biodegradable thermoplastic polymer or of one of their mixtures.

18. The packaging according to claim 17, wherein said biodegradable film (6) is watertight and/or adapted to form a gas barrier.

19. The packaging according to claim 16, wherein said biodegradable film (6) is composed of:
at least one cellulose-based layer (9);
at least one layer based on a resin or on at least one biodegradable thermoplastic polymer; or
at least one first layer, based on cellulose,
and one second layer, based on at least one resin and/or on at least one biodegradable thermoplastic polymer.

20. The packaging according to claim 19, wherein said cellulose-based layer (9) is kraft paper or sulfurized paper.

21. The packaging according to claim 19, wherein said cellulose-based layer (9) lays at least partially on said layer based on a resin or based on at least one biodegradable polymer (8), which itself lays on the biodegradable substrate (1).

22. The packaging according to claim 16, wherein the biodegradable thermoplastic polymer of the biodegradable film (6) or the biodegradable substrate (1) is selected from: poly(glycolic acid); polylactide (PLA), poly(lactic acid) (PLA) and copolymers thereof; polycaprolactone (PCL); polyhydroxyalkanoates (PHA); poly(ethylene adipate) (PEA); poly(ethylene succinate) (PES); poly(butylene succinate) (PBS); poly(butylene adipate) (PBA); poly(butylene adipate-co-terephthalate) (PBAT); poly(butylene succinate-co-adipate) (PBSA) or one of their mixtures.

23. The packaging according to claim 19, wherein the resin of the biodegradable film (6) is selected from: polyester, silicon or one of their mixtures.

24. The packaging according to claim 16, comprising angle areas (32) with cut-off corners.

25. The packaging according to claim 16, wherein the packaging is sealable.

26. A method for making a packaging (10) according to claim 16, implemented in an in-mould labelling (IML) injection device, in a mould that has a first portion and a second portion, the method comprising the following steps:
(a) placing the biodegradable film on the first portion of the mould having a wall, so that said biodegradable film covers at least partially said mould wall;
(b) putting into contact the first mould portion and the second mould portion, said second mould portion having a shape that is complementary to that of the packaging; and
(c) making the injection to form the biodegradable substrate (1) comprising openings (5), said biodegradable film being placed on the inner face of said biodegradable substrate (1) so as to obturate at least said openings (5);
(d) recovering the packaging (1).

27. The method according to claim 26, wherein said biodegradable film is composed of:
at least one cellulose-based layer (9);
at least one layer based on a resin or on at least one biodegradable thermoplastic polymer; or
at least one first layer (9), based on cellulose, and one second layer (8), based on a resin or on at least one biodegradable thermoplastic polymer.

28. The method according to claim 27, wherein the second layer is taken in sandwich between the biodegradable substrate (1) and the first cellulose layer (9).

29. The method according to claim 27, wherein said cellulose-based layer (9) is kraft paper or sulfurized paper.

30. The method according to claim 27, wherein the thermoplastic polymer layer of the biodegradable film is selected from a PLA, and/or the resin of the biodegradable film (6) is selected from: polyester, silicone, or one of their mixtures.

31. The method according to claim 30, wherein the thermoplastic polymer layer of the biodegradable film is a bi-oriented PLA.

32. The method according to claim 26, comprising, after step (d), a step of:
(e) sealing said packaging in a tray heat sealer.

33. A method for packing, storing, transporting foodstuffs or making capsules, comprising providing said foodstuffs into the packaging according to claim 16.

34. A method for cooking foodstuffs, comprising providing said foodstuffs into the packaging according to claim 16, and cooking them directly in said packaging.
